(19) United States
(12) Patent Application Publication
(10) Pub. No.: US 2021/0090160 A1
(43) Pub. Date: Mar. 25, 2021

(54) METHOD FOR PERFORMING AN AGRICULTURAL SERVICE

(71) Applicant: 365FarmNet Group KGaA mbH & Co. KG, Harsewinkel (DE)

(72) Inventor: Marten GRUNDMANN, Berlin (DE)

(73) Assignee: 365FarmNet Group KGaA mbH & Co. KG, Harsewinkel (DE)

(21) Appl. No.: 17/022,402

(22) Filed: Sep. 16, 2020

(30) Foreign Application Priority Data
Sep. 20, 2019 (DE) 10 2019 125 341.1

(51) Int. Cl. G06Q 30/08; G06Q 40/04; G06Q 30/02; G06Q 30/06

(52) U.S. Cl. CPC G06Q 30/08; G06Q 30/0601; G06Q 30/0275; G06Q 40/04

(57) ABSTRACT

A method for performing an agricultural service in which a server platform communicates with a user and with service providers. The server platform has a field file of field information about at least one agricultural field associated with the user. The server platform generates a service order based on the field information and on service instructions received from the user to perform an agricultural service with an order profile. The server platform generates service bids with a bid profile from service provider data of service providers. The server platform compares the order profile with the bid profiles, and suggests to the user one or more bids fitting the service order based on the degree of matching between the order profile and bid profiles. The server platform commissions the service provider of the selected bid to perform the service based on the user's selection of one of the service bids.

### CROSS-REFERENCE TO RELATED APPLICATIONS

This application claims priority under 35 USC 119 of German Application No. DE 10 2019 125 341.1, filed on Sep. 20, 2019, the disclosure of which is herein incorporated by reference.

### BACKGROUND OF THE INVENTION

The invention is directed to a method for performing an agricultural service by means of a server platform and to a server platform.

Agricultural services are at least partially outsourced in many agricultural operations. However, the individual user, in particular the farmer, is confronted by the problem that there is a vast number of service providers offering the requested agricultural service or similar agricultural service. Yet every provider is unique. For example, if the user wants to let a service provider perform crop protection, the user must select a crop protectant, possibly in coordination with the service provider, and coordinate whether and how the service provider can manage access to the agricultural field, which depends in turn on the available agricultural machinery of the service provider. But at the same time the quality of work, the speed, the price and the time of the service also depend on the agricultural machinery of the service provider. Not until all of these parameters have been agreed upon to the satisfaction of and within the capabilities of both the user and the service provider can the service be performed.

Heretofore, the user himself or herself had to inquire about or determine via the Internet, for example, the diverse available machinery among diverse service providers, to become at least somewhat familiar with the technical parameters of this machinery in order to assess whether or not it would be useful for the service desired by the user, to subsequently schedule appointments with the service providers in question and coordinate other parameters, negotiate the price and finally commission a service provider. Owing to the vast amount of information that is needed but largely unavailable, it is virtually impossible for the user to find the best service provider. Ultimately, therefore, the user's choice of service provider is largely a matter of chance.

### SUMMARY OF THE INVENTION

The problem upon which the invention is based is to configure and further develop the known method so as to increase the efficiency of the performance of agricultural services.

The above-stated problem is solved according to the invention by means a server platform having a field file which comprises the field information about at least one agricultural field associated with a user already holds the bulk of information that must be provided by the user to efficiently determine the requirements to be met by a service provider. If service providers also supply service provider data, it is possible to determine a degree of matching and to appreciably simplify the user's choice of the best service provider for him or her. Due to the high complexity of agricultural services, the abundance of information, for example, the technical characteristics of the agricultural machinery available to the service provider and the possibility of automatically processing large amounts of data, the suggested method must be implemented with the aid of computers.

In particular, a method is suggested for performing an agricultural service by means of a server platform, wherein the server platform communicates with a user and with a plurality of service providers. The server platform has a field file which comprises field information about at least one agricultural field associated with the user, wherein the server platform generates a service order in an order generation routine based on the field information and on service instructions received from the user to perform a field-specific agricultural service with an order profile. The server platform generates service bids in a bid generation routine with a bid profile in each instance from service provider data of service providers, wherein the server platform compares the order profile with the bid profiles in a comparison routine, determines a degree of matching between the order profile and the bid profiles and suggests to the user one or more service bids fitting the service order based on the degree of matching, and wherein the server platform commissions the service provider of the selected service bid to perform the service in an order award routine based on the user's selection of one of the service bids.

In a preferred embodiment, the order profile comprises an order parameter set with hard and soft order parameters. It has been recognized that there are some order parameters, namely, hard order parameters, the complete or virtually complete fulfillment of which is appreciably more important than the fulfillment of other order parameters, namely, soft order parameters. The type of service, for example, sowing, is a hard order parameter of this kind. If this hard order parameter is not met by a service bid, the service bid is unsuitable. In contrast, price can be a soft order parameter, since a slight deviation in price does not necessarily present a criterion for immediately excluding a service bid.

In the further preferred embodiment, the order parameters are at least partially classified by the server platform as hard or soft. Accordingly, work is accepted from the user, and it can be ensured that a user who does not possess the necessary expert knowledge is also assisted in the best possible manner.

In order to map the different importance of different order parameters, the degree of matching is developed based on a weighting of the soft order parameters. For example, a plurality of soft order parameters can be included in the determination of the degree of matching on the one hand, while it ensured on the other hand that the more important order parameters are not overlooked.

The field information can comprise information on the position of the agricultural field, particularly directions data, and/or information on the size of the agricultural field, particularly dimensions of the agricultural field, and/or information on the soil type of the agricultural field, and/or information on the crop of the agricultural field, particularly a crop type of the agricultural field. At least some of the field information is displayed to the user in the order generation routine, in that the user selects a portion of the field information as service instructions, and in that the service instructions are linked to the field information in order to generate the order profile of the service order, preferably in that the order profile is displayed to the user by the server platform, and the order profile is rejected or modified or accepted by the user. The order profile is generated in the order generation routine in an order generation subroutine interactively between the server platform and the user, in that the user is shown at least some of the field information, in that the user selects some of the field information as service instructions. The service instructions are linked to the field information in order to generate a partial order profile of the service order. Preferably, the partial order profile is displayed to the user by the server platform, and the partial order profile is rejected or modified or accepted by the user.

Following the order generation subroutine, field information which is prognosticated by the server platform from the partial order profile is determined, and the order generation subroutine is carried out again, wherein the prognosticated field information is displayed to the user in addition to or alternatively to a portion of the field information. Accordingly, the order parameters can be specified interactively one by one, while necessary input is carried out by the user.

The order profile is generated in the order generation routine in an order generation subroutine interactively between the server platform and the user. The user is shown at least some of the field information, and the user selects some of the field information as service instructions. The service instructions are linked to the field information in order to generate a partial order profile of the service order, which is preferably displayed to the user by the server platform, and the partial order profile is rejected or modified or accepted by the user.

Bid profiles are generated by the server platform in the bid generation routine from technical information of the service provider and/or from operational information of the service provider as service data of the respective service provider. The technical information of the service provider comprises the availability of machinery needed for the service order, particularly as hard bid parameter, and/or the suitability of the machinery for the service order, particularly as soft bid parameter, and/or the operational information of the service provider comprises an availability in terms of time of the service, particularly as hard bid parameter or soft bid parameter, and/or a price for the service, particularly as soft bid parameter.

In the preferred embodiment, the performance of the service by means of an agricultural machine is documented. While this documentation also provides information to the user, it serves primarily for improvement of the suggested method. Combined with the feedback of the user, the comparison routine can be improved by the server platform in a self-learning manner. This is provided in particular on the basis of the documentation and/or feedback.

A further possibility for optimizing the suggested method in a self-learning manner particularly on the basis of the documentation and/or feedback is indicated in claim 15.

The self-learning modification of the suggested method makes it possible to adapt the method to different users, different service providers and in general. Accordingly, the match between an expected service and a provided service especially can be improved for future applications of the suggested method.

According to a further teaching according to independent claim 16, a server platform adapted to implement a suggested method is claimed. Reference is made to all of the preceding statements with respect to the suggested method.

### BRIEF DESCRIPTION OF THE DRAWINGS

The invention will be described in more detail in the following referring to drawings showing only one embodiment example. In the drawings:

FIG. 1 shows a schematic diagram of the suggested method in the preferred embodiment form; and

FIG. 2 shows the suggested method carried forward particularly with respect to feedback and documentation.

### DETAILED DESCRIPTION OF THE EMBODIMENTS

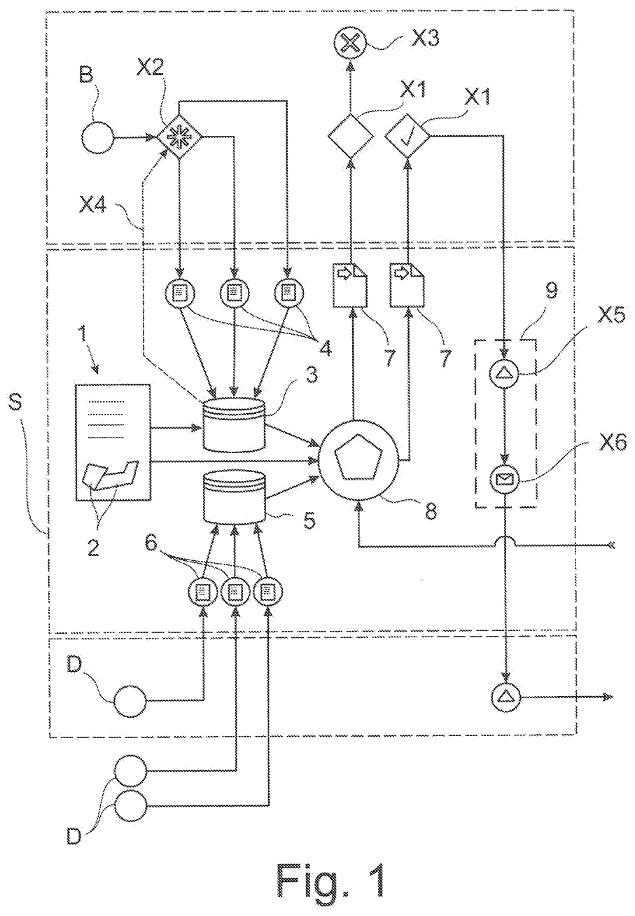

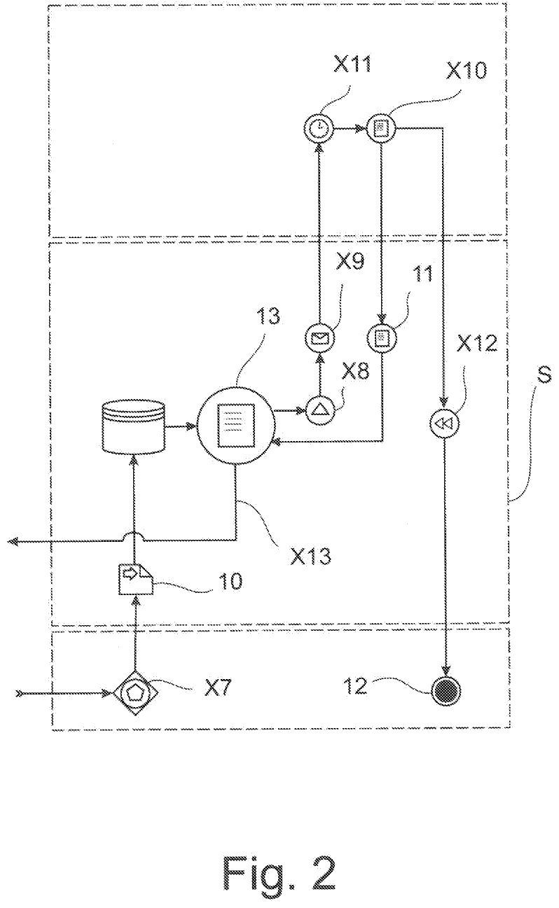

The method for performing an agricultural service shown in FIGS. 1 and 2 is implemented by means of a server platform S. The server platform S can comprise one or more servers and a computer program and need not necessarily be restricted to one location. The server platform S communicates with a user B and a plurality of service providers D. This communication can be provided in diverse ways. In the present instance and preferably, a real-time communication, particularly with the user B, is provided at least in part. The communication can proceed especially via the Internet. A display of a computer of the user B and of the respective service provider D is usually used in the communication. Alternatively, however, other devices, preferably a mobile device, particularly a smartphone, can also be used. It can also be provided generally that the server platform S comprises the computer and/or the mobile device of the user B and/or of the respective service provider D. Accordingly, for example, a part of a computer program of the server platform S may be installed in the computer. A decentral embodiment form of the server platform S in which, for example, only the computers of the user B and of the respective service providers D form the server platform S is also conceivable in principle.

The server platform S has a field file 1. The field file 1 comprises field information relating to at least one agricultural field 2 associated with the user B. A field file 1 of this kind can comprise a variety of information about a plurality of agricultural fields 2. This information is usually dynamic; that is, it is continuously adapted. In the present instance and preferably, the field information is also adapted during the suggested method.

The server platform S generates a service order to perform a field-specific agricultural service with an order profile in an order generation routine 3 based on the field information and service instructions 4 received from the user B.

In a bid generation routine 5, the server platform S generates service bids 7 with a bid profile, respectively, from service provider data 6 of service providers D.

The order generation routine 3 and the bid generation routine 5 can run in any sequence or even simultaneously. However, the service provider data 6 are preferably provided first. Further preferably, the order generation routine 3 is executed subsequently and, further preferably, the bid generation routine 5 is executed subsequently based at least partially on the order profile. Accordingly, the service provider data 6 can preferably basically already be stored in a server platform S, while the bid profiles are generated specifically for each order profile of a requested agricultural service.

In a comparison routine 8, the server platform S compares the order profile to the bid profiles. The server platform S determines in each instance a degree of matching between the order profile and the bid profiles and, based on the degree of matching, suggests to the user B one or more service bids 7 fitting the service order.

The server platform S preferably always suggests at least one service bid 7 to the user B. This is preferably the service bid 7 with the highest degree of matching. Further preferably, the server platform S always suggests to the user B a plurality of service bids 7 as far as possible. In the present instance and preferably, the server platform S suggests to the user B at least the three service bids 7 with the highest degree of matching. The server platform S preferably suggests to the user B at least the five service bids 7, further preferably at least the ten service bids 7, having the highest degree of matching.

The service bids 7 can be suggested to the user B particularly as a list which is sorted depending on the degree of matching.

It can then be provided that the user B selects one of the service bids 7. This is shown in FIG. 1 as selection possibility X1 in the top rectangle representing the actions of the user B. The center rectangle in FIG. 1 represents the server platform S, including actions thereof, and the bottom rectangle represents the actions of the selected service provider D. This applies in a corresponding manner for FIG. 2.

In an order award routine 9, the server platform S commissions the service provider D of the selected service bid 7 to perform the service based on the user's selection of one of the service bids 7. This is shown by way of example in FIG. 1 by a generation of the necessary data in step X5, “data generation”, and a transmission of the data in step X6, “data transmission”. Accordingly, in the further course of the method only the selected service provider D is relevant for the moment. The selected service provider D then preferably performs the service, particularly with at least one agricultural machine. In order to allow the service provider D to perform the service it is preferably provided that the server platform S sends part of the field information from the field file 1 relating to the agricultural field 2 affected by the service to the selected service provider D. More than one agricultural field 2 can also be affected. It is preferably provided that this field information is adapted to the ordered service. Accordingly, in particular, an automatically generated directions map which is adapted to the agricultural machines used during the service can be sent to the selected service provider D by the server platform S in the order award routine 9.

The suggested method will be briefly described referring to FIG. 1 using the example of a sampling of the soil of the agricultural field. For example, the user B retrieves the field file 1 on the server platform S, selects an agricultural field 2 from the latter and chooses three positions for sample drilling. This is represented by a user action X2 in FIG. 1. The user B then possibly chooses that he or she would like to have a groundwater amount determined. The server platform S then generates the order profile from these service instructions 4, from the field information, particularly soil information for the type of subsoil, a position of the agricultural field 2 and the known groundwater depth. The server platform S can now know from the service provider data 6 that basically five service providers D are contemplated for the service, three of which are active in the specified region. If the user B has also chosen that he or she wants a drilling depth of 20 m but the server platform S knows from the field information that the groundwater level is already at a depth of 10 m, the server platform S can suggest to the user B a first service provider D with a drill having a length of 30 m that is contemplated for the existing subsoil. Further, the server platform S can offer a second service provider D with a drill length of only 15 m, although at least the drill length of the second service provider D does not represent a complete match. The third service provider D with a drill length of 5 m would not be suggested. The user B can then select one of the two service bids 7 at selection possibility X1. The other service bid 7 is rejected (X3).

In the present instance and preferably, the order profile comprises an order parameter set with hard order parameters and soft order parameters. The hard order parameters differ from the soft order parameters in that they must be fulfilled in order for a service to be successfully executed. It can also be provided that the bid profiles comprise in each instance a bid parameter set particularly with hard bid parameters and soft bid parameters. The degree of matching can then be determined in the comparison routine 8 based on the soft order parameters and preferably the soft bid parameters. A soft order parameter of this kind could be the drilling depth mentioned above. In that example, the user B selected a drilling depth of 20 m, but a drilling depth of 15 m could also be sufficient for the required service. Conversely, a hard order parameter could be the minimum drilling depth of 10 m or the type of service, i.e., soil sampling. It is preferably provided that the hard order parameters are checked in the comparison routine 8 as to whether or not they match the bid parameters, and the results are shown particularly in a binary manner. Conversely, the soft order parameters preferably have a parameter range so that the degree of matching can be determined in a simple manner. In the example above, the second bid with a drilling depth of 15 m would have a lower degree of matching with the soft order parameter of drilling depth than the bid with a drilling depth of 30 m. Hard bid parameters and soft bid parameters can also be defined in an analogous manner. If a hard bid parameter, for example, an ability to pay, is not met by the user B, the user B is not considered for the service provider or, therefore, for the service bid 7. Here also, the hard bid parameters differ from the soft order parameters in that the hard bid parameters must be fulfilled.

Preferably, only service bids 7 in which all of the hard order parameters match the bid parameters are suggested to the user B. Further preferably, only service bids 7 in which all of the hard bid parameters match the order parameters are suggested to the user B. If a service provider D has determined, for example, that he or she will not undertake any groundwater drilling in spite of the option which exists in principle, this can be a hard bid parameter. Suggesting this service bid 7 to the user B would not often be productive.

In the present instance and preferably, the order parameters and preferably the bid parameters are at least partially classified by the server platform S as hard or soft. Additionally or alternatively, the order parameters can partially be classified as hard or soft by the user B and, again additionally or alternatively, the bid parameters can also be partially classified as hard or soft by the respective service provider D. It can be provided that the classification carried out by the user B and/or by the service provider D is partially modified by the server platform S in the comparison routine 8. Accordingly, referring again to the example above, the user could have classified the drilling depth as a hard order parameter but was mistaken about the depth of the groundwater level. This classification could be changed automatically by the server platform S to show the user B all relevant service bids 7.

In the present instance and preferably, the degree of matching is determined on the basis of a weighting of the soft and preferably of the hard order parameters and/or bid parameters. For example, a price could be heavily weighted and a time for providing the service could be lightly weighted, or vice versa. The weighting can be defined by the user B and/or determined automatically by the server platform S. Thus, in this case, for example, the user B could determine that the price is too heavily weighted, while the server platform S itself determines a weighting of the drilling depth in the example above.

In the present instance and preferably, a ranking of the service bids 7 is determined by the server platform S based on the degree of matching and is at least partially displayed to the user B.

The field information preferably comprises information on the position of the agricultural field 2, particularly directions data, and/or information on the size of the agricultural field 2, particularly dimensions of the agricultural field 2, and/or information on the soil type of the agricultural field 2, and/or information on the crop of the agricultural field 2, particularly a crop type of the agricultural field 2. Depending on the service, one or more of these field information data can be used for generating the order profile and/or sent to the service provider D.

The preferred flow of the order generation routine 3 will now be described in the following referring to FIG. 1. In the present instance and preferably, at least some of the field information is displayed to the user B in the order generation routine 3. The user B then selects a portion of the field information as service instructions 4. The service instructions 4 are linked to the field information in order to generate the order profile of the service order. Referring again to the example above, the user B selects three points for the soil sampling, for example, which are then linked to the subsoil at that location, the position thereof and directions to the field 2. Since the user B selects the sampling points based on a map of the agricultural field 2, this is also a selection of a portion of the field information. In the present instance and preferably, the order profile is displayed to the user B by the server platform S and is rejected or modified or accepted by the user B. The interaction with the user is indicated by arrow X4 which leads back to the user action X2. This refers back to the fact that the method on the whole largely proceeds from left to right in the drawing and from FIG. 1 to FIG. 2.

In the present instance and preferably, the order profile is generated in the order generation routine 3 in an order generation subroutine interactively between the server platform S and the user B. This takes place in that the user B is shown at least some of the field information, in that the user B selects some of the field information as service instructions, and in that the service instructions are linked to the field information in order to generate a partial order profile of the service order. The partial order profile is preferably displayed to the user B by the server platform S and is rejected or modified or accepted by the user B.

Following the order generation subroutine, field information which is prognosticated by the server platform S from the partial order profile can be determined. As discussed referring to the example above, it can be provided that the user B would like to carry out a sampling of the agricultural field 2. The partial order profile can then relate to this sampling. The server platform S can determine from this that a fertilizing of the agricultural field 2 can be provided after the sampling depending on the results. This can be the prognosticated field information. It can then generally be provided that the order generation subroutine is carried out again, and the prognosticated field information can be displayed to the user B in addition to or alternatively to a portion of the field information. Accordingly, if a possible groundwater level is displayed to the user as prognosticated field information, the user can request a fertilization of the agricultural field 2 as service based on the second order generation subroutine. Accordingly, a further partial order profile is generated in the second order generation subroutine. It is also conceivable that a plurality of order generation subroutines are executed without the services differing from one another. For example, the user B can be guided through a plurality of steps for generating the order profile by means of an interactive questionnaire. For example, the user B could also request a plurality of drill holes in different parts of the agricultural field 2 and define them individually, and the server platform S generates an approximate validity radius of the information gained from the sampling. The user B would probably not provide two drill holes in immediate proximity to one another, but it could be possible that this would nevertheless be required by a change in the soil type. The server platform S could then point out this information to the user B as prognosticated field information.

In the present instance and preferably, the service is a sowing, a fertilization, a soil sampling, a crop protection or a harvest.

In the present instance and preferably, bid profiles are generated by the server platform S in the bid generation routine 5 from technical information of the service provider D and/or from operational information of the service provider D as service data 6 of the respective service provider D. The technical information of the service provider D can preferably include the availability of machinery needed for the service order, particularly as hard bid parameters, and/or the suitability of the machinery for the service order, particularly as soft bid parameters. Additionally or alternatively, the operational information of the service provider D can be an availability in terms of the time of the service, particularly as hard bid parameter or soft bid parameter, and/or a price for the service, particularly as soft bid parameter.

A preferred expansion of the suggested method is described in the following referring to FIG. 2. During or after the performance of the service X7, the performance of the service X7 in the present instance and preferably is documented by the service provider D, particularly automatically by means of an agricultural machine, and the documentation 10 is transmitted to the server platform S. The documentation 10 can be generated, at least in part, by sensors of the agricultural machine. For example, the application of amounts of fertilizer to various positions of the agricultural field 2 can be documented.

In the present instance and preferably, the performance of the service X7 is displayed to the user B. For this purpose, the necessary information is preferably prepared in step X8, “data generation 2”, and is sent in step X9, “data transmission 2”. This can be carried out in particular based on the documentation 10. Further in the method (X11 “waiting time”), the user B in the present instance and preferably sends (step X10 “user transmission”) feedback 11 on the quality of the performance to the server platform S.

An evaluation of the service provider D can be generated by the server platform S from the feedback 11. However, the feedback 11 can also comprise an evaluation of the service provider D. In addition to the feedback 11, it can also be provided that a payment 12 is made to the service provider D by the user B and/or the server platform S. There is greater security for the user B particularly when the payment 12 is processed via the server platform S. The invoice X12 for the service can be generated automatically by the server platform S, particularly based on the documentation 10. This also saves labor on the part of the service provider D.

All or some of the steps mentioned above referring to FIG. 2 can be carried out in a checking routine 13. As is illustrated by arrow X13 leading back from the checking routine 13 to the comparison routine 8, which indicates information transmitted for self-learning, it can be provided that the comparison routine 8 is optimized by the server platform S in a self-learning manner. This optimization takes place in particular based on the documentation 10 and/or feedback 11. For example, if the user B is not satisfied with the performance of the service, but the documentation 10 shows that the service was carried out in accordance with the order, it can be determined by the server platform S that the order parameters of the server platform S were not generated in accordance with the wishes of the user B. Correspondingly, in the present instance and preferably, the comparison routine 8 is optimized based on the feedback 11 with respect to the preferences of the user B.

It can be provided that the weighting of the soft and preferably hard order parameters and/or bid parameters is optimized in a self-learning manner particularly based on the documentation 10 and/or feedback 11. For example, a poor weighting could be the reason for the dissatisfaction of the user B. Additionally or alternatively, it can be provided that the classification of the order parameters and/or bid parameters as hard or soft by the server platform S is optimized in a self-learning manner particularly based on the documentation 10 and/or the feedback 11.

According to a further teaching according to an independent claim, a server platform S is adapted to execute a suggested method. Reference is made to all of the statements referring to the suggested method. One or more computer programs which are configured for executing the suggested method or parts thereof, particularly the order generation routine 4 and/or the bid generation routine 5 and/or the comparison routine 8 and/or the order award routine 9 and/or the checking routine 13, are also the subject of an independent claim.

### REFERENCE CHARACTERS

1 field file
2 agricultural field
3 order generation routine
4 service instructions
5 bid generation routine
6 service provider data
7 service bids
8 comparison routine
9 order award routine
10 documentation
11 feedback
12 payment
13 checking routine
S server platform
B user
D service provider
X1 selection possibility
X2 user action
X3 rejection
X4 interaction with the user
X5 data generation
X6 data transmission
X7 performance of the service
X8 data generation 2
X9 data transmission 2
X10 user transmission
X11 waiting time
X12 invoicing
X13 information sent for self-learning

What is claimed is:

1. A method for performing an agricultural service by means of a server platform, comprising:
communicating with a user and with a plurality of service providers via the server platform, wherein the server platform has a field file which comprises field information about at least one agricultural field associated with the user,
generating with the server platform a service order in an order generation routine based on the field information and on service instructions received from the user to perform a field-specific agricultural service with an order profile,
generating with the server platform service bids in a bid generation routine with a bid profile from service provider data of each of the service providers,
comparing with the server platform the order profile with the bid profiles in a comparison routine, and determining a degree of matching between the order profile and the bid profiles
suggesting to the user with the server platform one or more service bids fitting the service order based on a degree of matching, and
commissioning the service provider of the selected service bid with the server platform to perform the service in an order award routine based on the user's selection of one of the service bids.

2. The method according to claim 1, wherein the order profile comprises an order parameter set with hard and soft order parameters, wherein the bid profiles each comprise a bid parameter set with hard bid parameters and soft bid parameters, and wherein the degree of matching is determined in the comparison routine based on the soft order parameters and the soft bid parameters, wherein only service bids in which all of the hard bid parameters match the order parameters are suggested to the user.

3. The method according to claim 2, wherein the order parameters and the bid parameters are at least partially classified as hard or soft by the server platform, wherein the order parameters are partially classified as hard or soft by the user or the bid parameters are partially classified as hard or soft by the respective service provider, and wherein the classification carried out by the user or by the service provider is partially modified by the server platform in the comparison routine.

4. The method according to claim 2, wherein the degree of matching is determined on the basis of a weighting of the soft and hard order parameters or bid parameters, and wherein a ranking of the service bids is determined by the server platform based on the degree of matching and is at least partially displayed to the user.

5. The method according to claim 1, wherein the field information comprises information on the position of an agricultural field, particularly directions data, or information on a size of the agricultural field, particularly dimensions of the agricultural field, or information on soil type of the agricultural field, or information on a crop of the agricultural field, particularly a crop type of the agricultural field.

6. The method according to claim 1, wherein at least some of the field information is displayed to the user in the order generation routine, wherein the user selects a portion of the field information as service instructions, and wherein the service instructions are linked to the field information in order to generate the order profile of the service order, wherein the order profile is displayed to the user by the server platform, and the order profile is rejected or modified or accepted by the user.

7. The method according to claim 1, wherein the order profile is generated in the order generation routine in an order generation subroutine interactively between the server platform and the user, wherein at least some of the field information is shown to the user, wherein the user selects some of the field information as service instructions, wherein the service instructions are linked to the field information in order to generate a partial order profile of the service order, and wherein the partial order profile is displayed to the user by the server platform, and the partial order profile is rejected or modified or accepted by the user.

8. The method according to claim 7, wherein, following the order generation subroutine, field information which is prognosticated by the server platform from the partial order profile is determined, and wherein the order generation subroutine is carried out again, wherein the prognosticated field information is displayed to the user in addition to or alternatively to a portion of the field information.

9. The method according to claim 1, wherein the service is a sowing, a fertilization, a soil sampling, a crop protection or a harvest.

10. The method according to claim 1, wherein bid profiles are generated by the server platform in the bid generation routine from technical information of the service provider and/or from operational information of the service provider as service data of the respective service provider.

11. The method according to claim 10, wherein the technical information of the service provider comprises the availability of machinery needed for the service order as a hard bid parameter, or the suitability of the machinery for the service order a soft bid parameter, or wherein the operational information of the service provider comprises an availability in terms of time of the service as a hard bid parameter or soft bid parameter, or a price for the service as a soft bid parameter.

12. The method according to claim 2, wherein performance of the service is automatically documented by the service provider, by means of an agricultural machine, and the documentation is transmitted to the server platform.

13. The method according to claim 1, wherein performance of the service is displayed to the user, and the user sends feedback on a quality of the performance to the server platform.

14. The method according to claim 12, wherein the comparison routine is optimized by the server platform in a self-learning manner, based on the documentation or the feedback, wherein the comparison routine is optimized with respect to preferences of the user based on the feedback.

15. The method according to claim 12, wherein weighting of the soft and hard order parameters or bid parameters is optimized in a self-learning manner based on the documentation and/or feedback, or wherein the classification of the order parameters and/or bid parameters as hard or soft by the server platform is optimized in a self-learning manner based on the documentation and/or the feedback.

16. A server platform adapted to execute a method according to claim 1.
